(19) United States
(12) Patent Application Publication
(10) Pub. No.: US 2007/0102521 A1
(43) Pub. Date: May 10, 2007

(54) METHOD AND SYSTEM FOR USING BARCODED CONTACT INFORMATION FOR COMPATIBLE USE WITH VARIOUS SOFTWARE

(76) Inventor: Urban Petersson, Stockholm (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 11/164,097

(22) Filed: Nov. 10, 2005

(51) Int. Cl. G06K 7/10; G06K 19/06

(52) U.S. Cl. 235/462.1; 235/494

(57) ABSTRACT

The present invention discloses a method and system for generating, analyzing and decoding a two-dimensional barcodes representing, for example, the contents of a business card or contact information in stored in a PDA or mobile phone. In an embodiment of the invention, a process is provided for generating a two-dimensional barcode from the contact information stored in a software database such as a Personal Information Manager (PIM), Customer Relationship Manager (CRM), PDA or mobile phone contact list. The contact data is exported from the database or handheld device into a standardized format such as vCard that is broadly used for exchanging contact information. The vCard data strings are encoded into Base64 and converted into the Unicode universal character set that provide wide ranging compatibility for various language scripts including many non-western character scripts. The data strings are encrypted and from which a unique two-dimensional barcode is generated that can be imprinted on business cards or on other printed material. In another embodiment of the invention, business cards and other printed material having a two-dimensional barcode generated by the invention can be quickly scanned such that the barcoded contact information is analyzed and converted for compatible use with numerous types of software such as personal information managers (PIM), Customer Relationship Managers (CRM), or electronic device contact lists without the need for supplementary user intervention.

### FIELD OF THE INVENTION

The present invention relates generally to reading, storing and retrieving contact information from business cards and other printed material. More particularly, the invention relates to reading high capacity two-dimensional barcodes imprinted on business cards that represented the contents of the card such that the data is converted into a format that is compatible for use with various types of personal information manager (PIM) software.

### BACKGROUND OF THE INVENTION

The practice of exchanging of business cards is a well known and universally accepted means for efficiently conveying information about the card holder. It is also customary to collect business cards in settings such as meetings, conferences, and business events, where under normal circumstances one can accumulate a multitude of cards over time. After a while these amassed cards become difficult to manage and it can be burdensome and time consuming to lookup information relating to a specific card at the time it is needed. Hence, it is important to be able to store and retrieve the contact information in an efficient and organized way in order to access what is often a valuable assortment contacts.

In the past these cards where often kept in a business card organizer, binder or rolodex which would be searched manually for the desired contact information. This sometimes meant that finding the contact information relating to a specific card can turn out to be very time consuming. One solution that has been implemented in the past that enables one to search quickly relates to digitizing the information and storing it in database of a computer system. While implementing a computer based system vastly improves search times, it often meant that that the information had to be tediously entered manually into the system and diligently updated. As a result many people are dissuaded by the effort required to use such a system properly.

U.S. Pat. No. 5,483,052 issued to Smith that describes a system for reading and storing information from a business card using two-dimensional barcodes. The barcode contains the information imprinted on the card relating to name, title, affiliation or company name, address and telephone numbers stored into discrete fields. The barcode is scanned by a battery powered pen-shaped scanner having a removable cap containing the scanned data on a RAM chip which can be uploaded to the memory of the computer or a personal organizer. The barcode that is read contains data that is adapted to be divided into predetermined discrete fields and is stored in a software database that is adapted to receive this particular configuration. This means that the database software must be configured to receive the discrete fields in a predetermined order thus may require the user to convert the fields when porting the data over to other software databases. Moreover, the scanner in Smith is more or less limited to scanning and decoding ASCII or western European characters. This precludes using the invention with business cards containing non-western characters such as Chinese and Japanese alphabetic scripts, or Middle Eastern right-to-left scripts. What is needed is a way to easily export the contact information to a computing device in a format that is compatible for use with various types of database software and has the ability to scan and decode non-western characters.

In U.S. Pat. No. 6,374,259 issued to Celik relates to a method for storing and retrieving business contact information in a computer system by matching a unique user identification number represented by a one-dimensional barcode printed on the business card. The contact information is subsequently stored in a remote database. Users retrieve the contact information by accessing the remote database via the Internet by entering a unique user identification number. The method reads the identification number in the barcode and matches it to the stored information. The use of a one-dimensional barcode limits the barcode capacity to no more than 30 characters, which is typically too short to contain the entire contents of the card.

FIG. 1 illustrates an exemplary one-dimensional barcode that comprises a collection of bars (vertical stripes) encoded in such a way to represent a string of characters. The barcode is one-dimensional because all the data is encoded in the horizontal direction so increasing the data capacity means increasing the width of the barcode. Barcodes are configured to easily ready by machine-readable scanners and have been widely used as a data key to access a lookup table for detailed product information in a database, such as at the supermarket checkout for example. The one-dimensional barcode used in the Celik method requires that the full contents of the business card are stored in a remote and separate storage medium. This means that the information is stored on a remote machine rather than on the requesting user's equipment. Since the nature of contact information can be confidential and highly valuable e.g. representing customer lists, some users may be uncomfortable with it being located remotely and under the direction of another party. Another problem is that the user needs to access the remote computer over the Internet and manually input the contact information in the database. It is thus desirable to provide a system where the business contact information can be automatically transmitted to a computer database that is under the direct control of the user thereby eliminating the need for manual data entry.

In view of the foregoing, it is desirable to provide a method and system for reading, storing and retrieving business contact information in an efficient and organized way that can read non-western characters scripts such that the data is readily compatible for automatic export to various types of software applications without requiring user intervention.

### SUMMARY OF THE INVENTION

In accordance with the embodiments and related features of the present invention, there is provided a system and method for overcoming at least some of the disadvantages associated with the method for reading and storing business contact information in the prior art.

In a general aspect, the present invention features a system for reading, converting, and storing business contact information that is compatible for automatic export to various personal information manager (PIM) applications without the need for supplementary user intervention.

To achieve these and other objects, the present invention provides a method and system for analyzing and decoding a two-dimensional barcode that includes, among other things, a representation of the contents comprising the contact information on a business card, for example. The data comprising the contact information is read, digitized and converted into a standardized text format that can be automatically exported and adapted for seamless operation with various types of personal information manager (PIM) software.

In a first embodiment of the present invention, a process for generating and printing a barcode from contact information stored in a software database such as a Personal Information Manager (PIM), Customer Relationship Manager (CRM), or mobile phone. The contact information can be previously stored information from e.g. a database or a contact list in handheld electronic device is transformed into a two-dimensional barcode that can be imprinted on a business card or on other printed material. The contact data can be exported from the database or handheld device into a standardized format such as vCard that is typically used for exchanging contact information. The vCard data is encoded into Base64 and converted into the Unicode universal character set to provide wide ranging compatibility for various language scripts that include many non-western character scripts where the data strings are then encrypted. A unique two-dimensional barcode, generated from the data strings, can be readily imprinted on material for business cards or on other printed material. It should be noted that encoding into Base64 and the encryption of the data strings are optional steps and it is possible for the invention to generate barcodes without using such techniques.

In a reading aspect of the invention, an ordinary flatbed scanner, a handheld scanner, or a digital camera is used to scan a two-dimensional barcode imprinted on the business card or other printed material. The scanner is coupled to a computer or a handheld device such as a PDA via a cable or wireless connection such as Bluetooth or Infra-red link. The data is encrypted and converted to the Unicode universal character set, which enables the system to handle virtually all character scripts including non-western character scripts, and encoded into Base64. Conversion to Unicode and Base64 is performed to ensure that the data is kept in its original format while converting to and from the barcode format. The encoded data is extracted to standard vCard format where the text is divided into a plurality of fields associated with the contact information that is compatible for automatic export to various types of PIM applications such as e.g. MS Outlook™.

In a further embodiment, the system is implemented for use in registering information relating to attendees at an event, conference, tradeshow or similar occasion. The attendee information can be printed out on a nametag, ID badge or business card for use at the occasion.

In a still further embodiment, a digital camera included a mobile phone or PDA is used to capture images of the two-dimensional barcode on the business card or other printed material. The data is encrypted and converted to the Unicode universal character set, which enables the system to handle virtually all non-western character scripts, and encoded into Base64. The encoded data is extracted to standard vCard format where the text is divided into a plurality of fields associated with the contact information that is compatible for automatic import to a contact list in the mobile phone or PDA.

### BRIEF DESCRIPTION OF THE DRAWINGS

The invention, together with further objectives and advantages thereof, may best be understood by reference to the following description taken in conjunction with the accompanying drawings in which:

FIG. 1 illustrates an exemplary one-dimensional barcode;

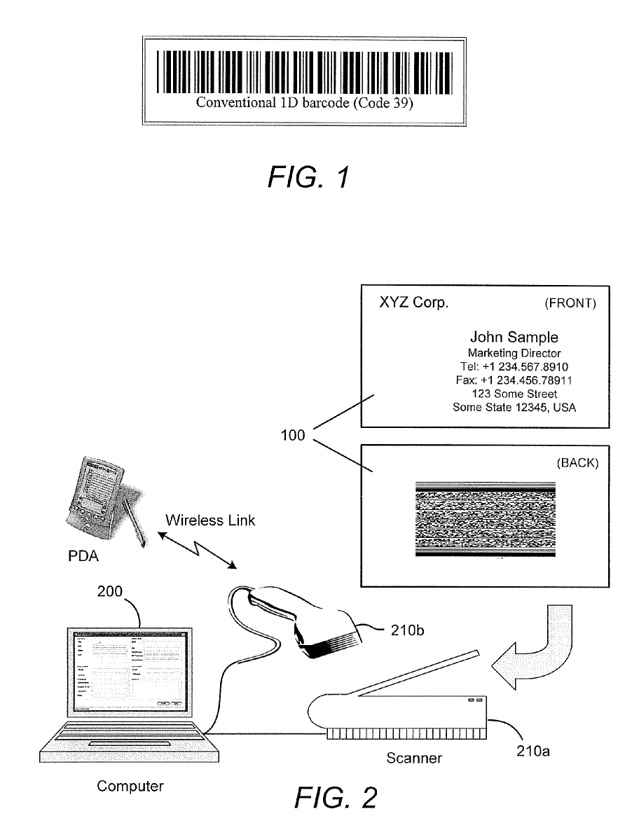

FIG. 2 depicts the system for reading and storing business contact information operating in accordance with a first embodiment of the present invention;

FIGS. 3A-3D depict a flow diagrams illustrating writing and reading processes and information handling and barcode output procedures operating in accordance with a first embodiment;

FIG. 4 shows a registration system for attendees at conference or tradeshow events operating in accordance with a second embodiment; and

FIG. 5 shows a system using a digital camera of a mobile phone for reading two-dimensional barcodes operating in accordance with a third embodiment.

### DETAILED DESCRIPTION OF THE INVENTION

The following description relates to embodiments of the present invention that are described in detail with reference to the drawings.

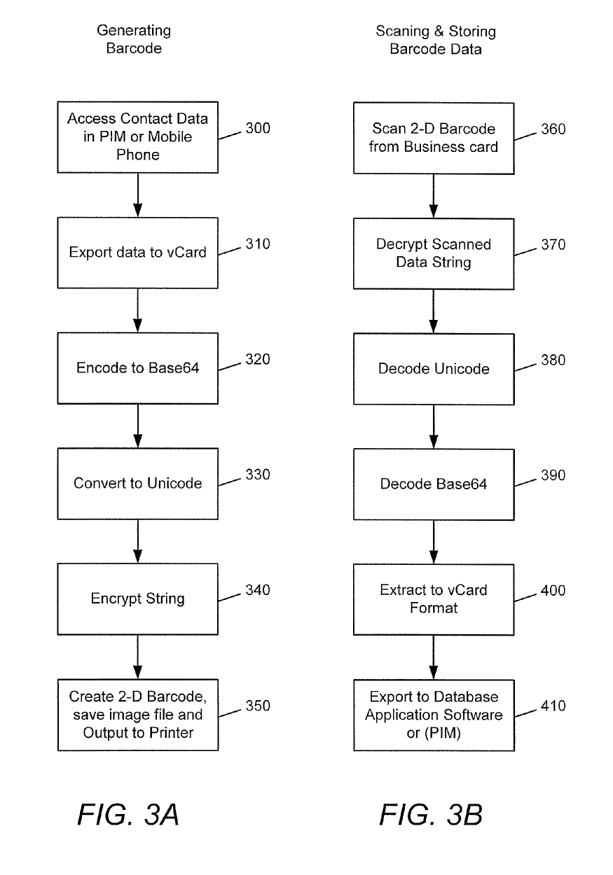

Referring now to FIG. 2, a system for reading, converting, and storing business contact information without the need for additional user intervention is described in accordance with a first embodiment of the present invention. An exemplary business card is shown generally as 100 that contain a variety of contact information printed on the front of the card. The contact information can include information divided into separate fields such as company name, first name, last name, title, address, city, state, zip code, country, phone number, fax number, email address, a website address etc. It should be understood that the invention is not limited to the information shown but can comprise other types of information such as graphics, trademarks or logos, for example. All data on the business card, or as much as desired, can be encoded in a high density two-dimensional barcode containing a machine-readable representation of the contents of the card, which as shown in the figure is imprinted on the back of the card. It should further be understood that the barcode can be imprinted anywhere on the business card, size permitting, such as on the front side of the card.

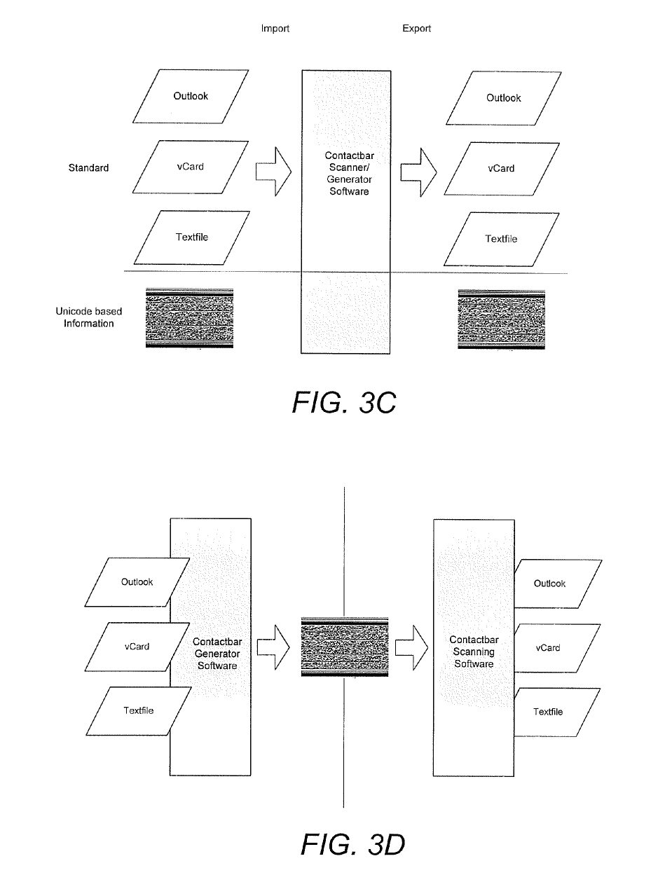

FIG. 3A is a flow diagram illustrating the process for generating a barcode from stored data operating in accordance with the first embodiment. It should be noted that some steps are optional and that some may be omitted without affecting the operation of the invention. Contact data, once stored in the database, PIM or mobile phone, can be readily transformed into a 2-D barcode to be imprinted on a business card, other printed material or on individual products or items. The data from which a two-dimensional barcode is to be generated is accessed in the contact database, PIM or mobile phone, as shown in step 300. Many PIMs and mobile phones provide a way to export stored contact records into a universal vCard format for transfer purposes (step 310). The barcode data is translated into a data string comprising of field separators and information text in conformity with those used in vCard. The data strings are encoded in Base64 that enables the data is kept in its original format while converting to and from the barcode format, as shown in step 320. The Base64 encoded data is then converted to the Unicode universal character set (step 330) to provide wide ranging compatibility for various language scripts, as previously described. The data string is encrypted in step 340 using placement keys where the data is divided into packages and put together using the placement keys when reading. The strings are translated into a unique two-dimensional barcode that can be saved in an image format such as TIFF that can be readily imprinted on material for business card, other printed material or on individual products or items, as shown in step 350.

The two-dimensional barcode used in the invention can be any high density barcode such as those conforming to the PDF417, the Matrix, or the GM 1724 two-dimensional barcode standards. The printed symbol of a PDF417 barcode consists of several linear rows of stacked code words. Each codeword represents 1 of 929 possible values from one of three different clusters. A different cluster is chosen for each row, repeating after every three rows and since the code words in each cluster are unique, scanners are able to determine what line each cluster is from when it is scanned. The PDF417 standard can store approximately over 1,800 printable ASCII characters or 1,100 binary characters per symbol. It should be noted that the storage capacity is formally restricted and can be adjusted to specific application requirements. The symbol is rectangular and the shape of the symbol can be adjusted to some extent by setting the width and allowing the height to grow with the data. However, the maximum data density is typically determined by the smallest elements which can be reliably printed and scanned. For example, with many laser printers used currently, the smallest recommended element size of 0.0075 inch wide and 0.010 inch high. Thus data density in the binary mode is approximately 686 bytes per square inch or 106.2 bytes per square centimeter, for example. In the printable ASCII mode the density achieved can be at least 1,144 characters per square inch (177.2 characters per square centimeter) or more, where improvements in print technology may allow for even greater densities.

PDF417 also advantageously permits large amounts of data to be broken down into several PDF417 symbols that are logically linked since there is no theoretical limit on the amount of data that can be stored in a group of symbols. The relatively large capacity of barcode enables all the information on the business card to be included in the barcode without the need for a host database to quickly lookup the data, as would be the case when using a one-dimensional barcode. Moreover, PDF417 is robust in that it has built-in error-correcting capability that works by making calculations to reconstruct corrupted or un-decoded portions of the symbol, such as when portions of the barcode label gets destroyed. Another advantage is that the barcode can contain various bits of information in addition to contact information data.

Reading two-dimensional barcode symbols requires a 2-D scanner such as an ordinary flatbed scanner 210a, a handheld 2-D scanner 210b, or a digital camera. This is in contrast to the ordinary pen or wand scanners that are typically used to scan 1-D barcodes. There are many scanners on market that can be used with the present invention e.g. those using either laser or CCD digital camera technologies are suitable. The scanned data can be transferred to a computer 200, or a portable computing device such as a PDA or a mobile phone, having decoding software that can recognize the digital images of the barcode. The connection between the computing device and the scanner can be established by wireless means such as via Bluetooth or wireless LAN.

In accordance with the a reading aspect of the embodiment, the scanned data is converted to standard format such as the vCard version 3, which is compatible with various types of contact information storage database applications. The vCard standard allows the applications to exchange contact information interchangeably and automatically, provided that the devices are able to communicate with each other. By way of example, communication means may occur via Bluetooth enabled devices such as mobile phones and PDAs. Infrared links between devices can also be used. Examples of vCard-enabled applications include email, personal information managers (PIMs), Customer Relationship Managers (CRMs) voice mail, Web browsers, telephony applications, and video conference applications. A vCard file is a text file having a specified layout of fields, delimiters and data that is saved with a .vcf file extension. The .vcf extension is used by many programs to automate the exchange of contact information such that they are media and protocol independent thereby making them ideal for cross-platform use. The vCard standard has broad industry acceptance and was developed by the Internet Mail Consortium, can include, in addition to text based contact information, URLS, images, logos, and audio clips for example. Contact information can be easily imported via vCard data using most Customer Relation Management (CRM) systems and many book keeping systems.

A vCard file has various predefined data fields that are specified such as company name, first name, last name, title, phone number, fax number etc. Consider the following information on a business card:

Name: John Sample

E-Mail Address: john.sample@domain.com

Title: Marketing Manager

Business Phone: +1 234.567.8910

Mobile number: +1 234.567.8912

Company Name: XYZ Corporation

Street Address: 123. Some Street

City: Some city

State: Some State

Zip Code: 12345

Country: United States of America

The corresponding vCard file looks something like:

BEGIN:VCARD

VERSION:2.1

N:Sample;John

FN:John Sample

ORG: XYZ Corporation

TITLE:Marketing Manager

TEL;WORK;VOICE: +1 234.567.8910

TEL;CELL;VOICE: +1 234.567.8912

ADR;WORK:;; 123 Some Street; Some city; Some State; 12345;United States of America

EMAIL;PREF;INTERNET: john.sample@domain.com

END:VCARD

The vCard data can be automatically exported to any compatible PIM application where the contact information is entered in the associated fields providing virtually universal exportability to many different applications.

FIG. 3B is a flow diagram illustrating the process for reading and storing data from a barcode operating in accordance with the first embodiment. It should be noted that some steps are optional and that some may be omitted without affecting the operation of the invention. The barcode is scanned in step 360 and translated into a code string by using scanning software such as Barcode Reader .Net SDK by Tasman Software, Minnesota, USA. The scanned data strings can be encrypted e.g. to provide additional security and improve the resistance tampering of the barcode, are decrypted using the code keys of the encryption information code keys as shown in step 370. Furthermore, the encryption provides unique a encoding so that, for example, Roger Smith at XYZ Corporation can be definitively distinguished from Roger Smith at ABC Corporation to avoid confusion.

The encryption method used need not be complicated; however, depending on the encryption strength desired the key can be a random number integer between 0 and 255 that is converted to a two-bit hexadecimal value. The first character in the string is then encrypted using the algorithm:
Encryption=X+(SIN(P+K*0.4)*10)

where,

X=The first character in the string

P=The characters position in the string

K=The key converted to integer

To decrypt the characters the encryption is converted to characters based on the calculated value.

Moreover, the final string that is saved or read is:
Version # (for reverse compatibility)+Encryption String+CRC+KEY.

The version # is a label indicates which version of the code is generated that enables the development the code that is backward compatible with older versions of code. The result is a barcode having a final encrypted string that is unique and definitively distinguishable from another barcode even from those containing the same encrypted data.

In step 380, the contact data string comprising the Unicode universal character set data is decoded. Unicode is an international standard that defines codes for characters for all the major written languages in use today. It includes all scripts currently in active use such as the European alphabetic scripts, Middle Eastern right-to-left scripts, and many scripts of Asia. Unicode also includes a plethora of symbols, punctuation marks, diacritics, mathematical symbols, technical symbols, arrows, dingbats, etc. Moreover, it contains additional characters for interoperability with older character encodings, and characters with control-like functions included primarily for reasons of providing unambiguous interpretation of plain text, such as codes for diacritics, which are modifying character marks such as the tilde (˜), that are used in conjunction with base characters to represent accented letters. The advantage of Unicode is that it provides specifications for use of all of these characters and more. In total the Unicode Version 4.0 Standard provides codes over 96,000 characters from the world's alphabets, ideograph sets, and symbol collections. Although the use of Unicode is optional in the present invention, its use enables the scope of languages of business cards that can be successfully scanned and recognized to be greatly expanded.

Following encoding in Unicode the data is further encoded using Base64, as shown in step 390. The traditional use of Base64 was as an encoding format for transferring attachments in email. However, it can be used anytime binary or arbitrary data needs to be represented in common printable characters, such as connecting to web pages requiring a username and password for basic authentication where Base64 is used encode the username and password, for example. An advantage of using Base64 is that it rigorously maps specific characters to specific values, for example, an ‘A’ is always has a value of 0 regardless of the character set used and that it uses only characters that are very likely to cleanly pass through mail servers with different architectures. Among other things, conversion to Base64 ensures that the data is kept in its original format while converting to and from the barcode format.

In accordance with the embodiment, the Base64 decoding collects the contact object from the destination application such as Outlook™, vCard, or CSV text file format where data fields are typically delimited by e.g. commas. The information string is read to identify the field separators for the appropriate application and inserts the information from the string of the 2-D barcode into the correct corresponding field for the application. By way of example, if the target is vCard the data is extracted into corresponding predefined fields of vCard, as shown in step 400. The vCard format provides a widely used format for exporting the contact information to various PIM software applications, as shown in step 410 and described in the aforementioned paragraphs. It should be noted that the invention can also be adapted to import and export contact information contained in text files such as comma separated value (CSV) text files. In such case both the sending and receiving application must use compatible predefined text fields for ensuring correct transfers.

FIG. 3C is an exemplary illustration of the information handling procedure for the import/export of contact information in accordance with the invention. The term “contactbar” is used herein to refer in general to integrated software that executes and controls the functions for generating, reading and decoding barcodes as practiced in the present invention. For example, there are available software packages that work well with the invention for creating and saving text to PDF417 barcodes such as MW5 PDF417 Net Control by MW6 Technologies, Inc., Calgary, Canada. Other software that can be used in the invention for reading and scanning PDF417 barcodes is Barcode Reader .Net SDK by Tasman Software, Minnesota, USA. The contactbar software can be used to import or export contact information. When import/exporting between the contactbar program and Outlook™, vCard or CSV (text file), the program is affected by the standard character setting loaded on the current users work station (PC). Thus, Unicode based character scripts in the contactbar may be read and generated successfully when the associated character settings are available on the PC.

In the import stage, the information is imported from Outlook™ or a text file and converted to vCard format prior to input to the contactbar software. It should be noted that the Contact object information is not converted (Base64, Unicode, encryption) at this stage in order to make the import/export faster between contactbar and Outlook™, vCard and text file.

When a barcode is created the information is translated to Unicode, which is readable regardless of standard character settings i.e. no information is distorted, and is encrypted to be readable only through contactbar.

FIG. 3D is an exemplary illustration of the barcode generating and scanning procedures. Since the contactbar software translates the information in its contact object-to-Unicode when a bar code is generated, the information is readable globally. Furthermore, the contact object from Outlook™ and vCard are character script “sensitive” since they only can be read in the same environment from which they where created. For example, a Japanese vCard containing Japanese characters can only be read on a computer having a Japanese character set available, otherwise the vCard can be created but the data cannot be read.

The previous description has primarily related to the reading and storage of contact information from barcoded data. The invention can be used to produce barcodes from previously entered contact information that can be imprinted on business cards and the like. In accordance with a further embodiment of the invention, a system is described that is operable for producing 2-D barcode symbols from contact information that is already in the computer systems. These barcodes can be readily imprinted on business cards and other printed material or products. One example could be to generate and attach a barcode on a piece of luggage or other personal item so that if it gets misplaced the lost and found department or other authority can quickly scan it to obtain owner information and a message could automatically be sent to the owner using e.g. SMS text messaging to a mobile phone, voice mail, e-mail etc. The system can also be suitably used to provide attendees of events, meetings, conferences, or tradeshows with quickly created registration nametags or ID badges.

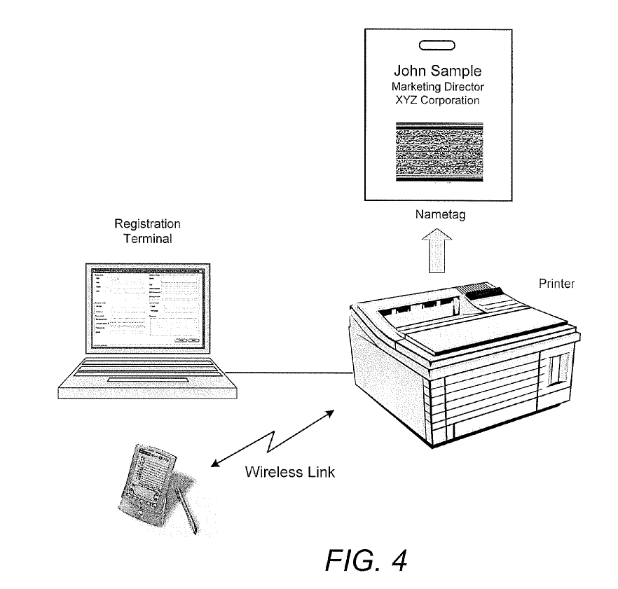

FIG. 4 shows such an arrangement for printing out registration nametags for an event, conference, tradeshow or similar event in accordance with a second embodiment of the present invention. Major events such as tradeshows often require the attendees to register prior to attending the event since it enables the organizers to conveniently keep track of everyone attending the event. The attendee typically enters his registration details into a computer terminal or a portable computing device at the registration area that generally includes personal information such as his or her name, affiliated company, address etc. The registration system can be used for registering attendees in advance or for those registering upon arrival at the event. The registration information is stored in a database for storage and processing by the computing device for event organizers. The computing device can be in wireless communication with other devices e.g. via Bluetooth. Once the information is in the system a nametag can be printed listing suitable particulars of the individual together with a scannable 2-D barcode (herein referred to as a “contactbar”) imprinted thereon containing contact information such as that on his business card or any other information that the attendee wishes to convey.

When an attendee visits a particular booth or exhibit, the booth operator can record the visit by scanning the bar-coded portion 151 of identification badge 15 using scanner 22, thereby storing the Attendee's registration number in information storage unit 21. In addition, if the attendee makes specific inquiries or requests certain information about the products or services on display at a particular booth or exhibit, the booth or exhibit is equipped with a hard copy menu 23, which lists a number of standard requests for information in both human-readable and bar-coded form. For example, an attendee may request a product brochure or other information regarding a specific product or service. Rather than having to notate this request by hand, the booth operator merely scans with bar code scanner 22 the requestor's identification badge to record his registration number and the bar-coded portion of menu 23 which corresponds to that particular request, to record the request in information storage unit 21 along with the requestor's registration number. Multiple requests may be recorded by successively scanning the respective bar-coded portions of menu 23. Menu 23 may be printed in advance to include a number of standard requests most commonly made by visitors to a booth or exhibit at a trade show. A unique bar code is assigned to each such standard request on the menu. Alternatively, each individual booth operator may make up his own set of requests and assign a unique bar code to each of such requests on menu 23, so that menu 23 can be customized to suit the needs of the individual booth operator.

The nametag, in addition to enabling fellow attendees to read the name of the person, it allows the operators of booths that have the suitable equipment to record who it was that visited by quickly scanning the barcode on the nametag. In addition it allows the operator to identify specifically which inquiries about his display were made by whom, which can be very useful for later reference. One technique that could be used would be to have the operator match the attendee nametag with an inquiry from a barcoded inquiry list of e.g. preprinted barcodes associated with the particular inquiry by quickly scanning both barcodes. The requests are be recorded by successively scanning the respective barcode on the barcoded inquiry list and subsequently the contactbar on the attendee's nametag thereby enabling the booth operator to obtain all information on the attendee that the attendee wishes to convey directly from the contactbar barcode. The list would include many of the most common requests that are most visitors are likely to make such as to receive a brochure or product inquires. The system is flexible and can be adapted in such a way to suit the needs of the individual booth operator.

The information in the barcode can also include additional information such as their business card, company logos, picture files, or even small software programs that one may want to transmit. Furthermore, it can include information to indicate or confirm that the attendee may have the right to enter areas for special activities or limited entry areas such as backstage premises at a specific function, for example.

In relation to a further aspect of the invention, a digital camera such as in a mobile phone may be used to capture images of barcodes in lieu of a scanner. Scanners translate the scanned item into a digital image in, for example, .jpg, .gif or .bmp format where it is sent to the computer. Similarly, the captured image from a digital camera can transmit the barcode to the computer or PDA in the appropriate image file type which can be decoded using software on the computing device. The text data can then be converted, and exported to a PIM or CRM from the vCard format using the same steps as described in relation to the previous embodiments.

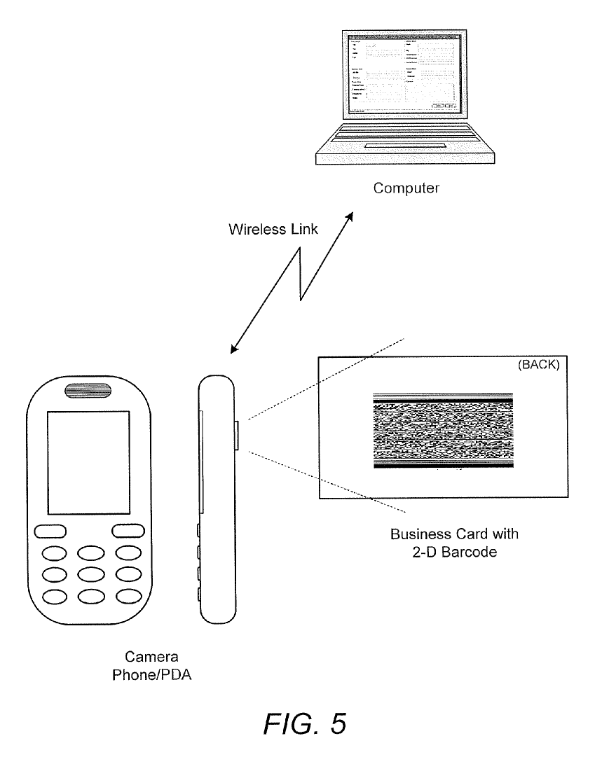

FIG. 5 shows an exemplary system using a mobile phone for obtaining contact information from a barcode in accordance with a third embodiment of the invention. The embodiment implements a mobile phone having a built-in digital camera for capturing the image of the barcode. As digital cameras become more and more pervasive in everyday life, it is possible to use them to scan documents into digital images. By way of example, it is possible to use the CCD in digital cameras that come with many of present-day mobile phones as a handheld scanner. The image is transmitted wirelessly from the mobile phone to the computing device for analysis, decoding and conversion of the data for automatic export to various PIM applications in the manner described in the previous embodiments. Furthermore, the embodiment enables one to scan a business card with a printed two-dimensional barcode such that the contact information is automatically entered into the address book of the phone.

The foregoing description of the preferred embodiments of the invention has been presented for purposes of illustration and description. It is not intended to be exhaustive or to limit the invention to the precise forms disclosed, since many modifications or variations thereof are possible in light of the above teaching. Accordingly, it is to be understood that such modifications and variations are believed to fall within the scope of the invention. The embodiment was chosen to explain the principles of the invention and its practical application, thereby enabling those skilled in the art to utilize the invention for the particular use contemplated. It is therefore the intention that the following claims not be given a restrictive interpretation but should be viewed to encompass variations and modifications that are derived from the inventive subject matter disclosed.

What is claimed is:

1. A method of generating a two-dimensional barcode representing the contact information from a business card from stored data, wherein the contact information is accessible via application software and stored on storage means in communication with a computing device, wherein the contact information is included in a barcode adapted to be imprinted on a business card or other printed material or items, said method comprising the steps of:
exporting the contact information into vCard format forming data strings such that the output text is extracted into of a plurality of separate fields associated with the contact information on the business card;
converting the data strings to the Unicode international character set;
generating the two-dimensional barcode from the converted Unicode data strings; and
imprinting said two-dimensional barcode on the business card or other printed material.

2. The method according to claim 1, wherein the generated two-dimensional barcode is a high density barcode conforming to the PDF417, the Matrix, or the GM 1724 standard that is read by said reader device.

3. The method according to claim 1, wherein the application software comprising the contact information is e.g. a Personal Information Manager (PIM), Customer Relationship Managers (CRM) software running on the computer or a handheld computing device.

4. The method according to claim 1 wherein, the data strings are encrypted with an encryption key where the algorithm is X+(SIN(P+K*0.4)*10), and wherein the final string is determined by Version #+Encryption String+CRC+KEY.

5. The method according to claim 1, wherein the data strings are encoded into the Base64 encoding standard.

6. The method according to claim 1, wherein the method is implemented to register information relating to attendees at an event, conference, tradeshow or similar, wherein information entered into the computing device is printed out to produce a nametag or business card for use for said occasion.

7. The method according to claim 1, wherein the two-dimensional barcode that further comprises logos, picture files, audio clips, URLS, and small software programs.

8. A method of analyzing and decoding a two-dimensional barcode representing the contents of a business card and imprinted thereon such that a reader device adapted to read said barcode is coupled to a computing device for storing and retrieving contact information relating to the business card, said method comprising the steps of:
reading the barcode imprinted on the business card and converting the read information into digital data;
extracting the digital data into standard vCard format such that the output text is extracted into of a plurality of separate fields associated with the contact information on the business card; and
exporting the vCard output text such that it is automatically exported to and seamlessly operates with various types of contact information database software.

9. The method according to claim 8, wherein the read data is converted to the Unicode international standard character set capable of representing western and non-western scripts.

10. The method according to claim 8, wherein the read data is into the Base64 encoding standard.

11. The method according to claim 8, wherein the two-dimensional barcode is a high density barcode conforming to the PDF417, the Matrix, or the GM 1724 standard that is read by said reader device.

12. The method according to claim 8 wherein, the extracted vCard data is text that is transmitted via a wireless connection such as by Bluetooth or infra-red links.

13. The method according to claim 8, wherein the vCard data is exported to contact information database software such as Personal Information Manager (PIM) and Customer Relationship Manager (CRM) software running on a computer or a handheld computing device.

14. The method according to claim 8 wherein, the read data from the barcode is encrypted with an encryption key where the algorithm is X+(SIN(P+K*0.4)*10), and wherein the final string is determined by Version #+Encryption String+CRC+KEY.

15. The method according to claim 13, wherein the method is implemented to register information relating to attendees at an event, conference, tradeshow or similar, wherein information entered into the computing device is printed out to produce a nametag or business card for use for said occasion.

16. The method according to claim 8, wherein the reading device is capable of reading the two-dimensional barcode that further comprises logos, picture files, audio clips, URLS, and small software programs.

17. The method according to claim 8 wherein, the reading is performed using any one of a standard flat bed scanner, two-dimensional handheld scanner, handheld digital camera, and a mobile camera phone.

18. The method according to claim 8 wherein, the digital data is exported into a text file such as a CSV text file for export to the contact information database software.

19. A system for generating a two-dimensional barcode, representing contact information for imprinting on business card or other printed material or items, from a database comprising the contact information, said system comprising:
means for exporting the contact information from said database to vCard format wherein the data strings are extracted into of a plurality of separate fields associated with the contact information on the business card;
means for converting said data strings into Unicode;
means for generating a two-dimensional barcode from the converted Unicode data strings; and
means for imprinting said two-dimensional barcode on a business card or other printed material.

20. A system according to claim 19, wherein the 2-D barcode is a high density barcode conforming to the PDF417, the Matrix, or the GM 1724 standard.

21. A system according to claim 19, further comprises means to convert the digital data into the Base64 encoding standard.

22. A system according to claim 19, further comprises means to encrypt the digital data using the algorithm is X+(SIN(P+K*0.4)*10), and wherein the final string is determined by Version #+Encryption String+CRC+KEY.

23. A system according to claim 19, wherein the two-dimensional barcode further comprises logos, picture files, audio clips, URLS, and small software programs.

24. A system according to claim 19, wherein the system is used to register information relating to attendees at an event, conference, tradeshow or similar occasion, wherein information entered into the computing device is printed out to produce a nametag or business card for use for said occasion.

25. A system according to claim 24, wherein the computing device is a remote stationary computer or handheld device such as PDA that is in communication with the reader device via wireless connection means such as Bluetooth or a infra-red link.

26. A system according to claim 19, wherein the barcode is imprinted on a product that may become lost such that the owner's information is obtained by scanning the barcode and a message is automatically be sent to the owner using any one of SMS text messaging to a mobile phone, voice mail, and e-mail.
